(19) United States
(12) Patent Application Publication
(10) Pub. No.: US 2011/0202871 A1
(43) Pub. Date: Aug. 18, 2011

(54) METHOD AND SYSTEM FOR SCROLLING THROUGH A GRAPHICAL USER INTERFACE LIST CONTROL

(75) Inventors: Richard Allen Bair, Manteca, CA (US); Jasper James Charles Potts, Bath (GB)

(73) Assignee: ORACLE INTERNATIONAL CORPORATION, Redwood Shores, CA (US)

(21) Appl. No.: 12/707,364

(22) Filed: Feb. 17, 2010

(51) Int. Cl. G06F 3/048

(52) U.S. Cl. 715/786

(57) ABSTRACT

A method and system for scrolling through a graphical user interface list control. A relative scrollbar position is obtained for a scrollbar thumb in a scrollbar associated with a scrollable window configured to display data items belonging to a list. A primary data item is determined having a relative list position. The relative list position corresponds to a relative scrollbar position for the scrollbar thumb in the scrollbar. A relative scrollable window position in the scrollable window is determined. The relative scrollable window position in the scrollable window corresponds to the relative scrollbar position for the scrollbar thumb in the scrollbar. The primary data item is displayed at the relative scrollable window position in the scrollable window.

### BACKGROUND

A modern computer system may be conceptually divided into hardware, operating system, and application programs. Hardware (i.e., central processing unit (CPU), memory, persistent storage devices, and input/output (I/O) devices) provides the basic computing resources. An example of a hardware function is storage. For example, a persistent storage device may be used to maintain data for retrieval by the operating system or an application program.

An operating system is a program that acts as an intermediary between the application program layer and the computer hardware. To this end, the operating system is involved in coordinating the use of the hardware resources to enable a broad range of computative tasks (i.e., memory management, hardware resource management, maintaining a file system, processing user-level requests, administrative tasks, networking tasks, etc.).

An application program (i.e., compilers, database systems, software, and business programs) defines how these hardware resources are used to solve the computing problems of the users. The users may include people, machines, and other computers that use the application programs, which in turn employ hardware resources to solve numerous types of problems. For example, a user may use an application program to access information which is stored in a computer system's persistent storage. To this end, an application program may function as a means for receiving input from and providing output to a user.

### SUMMARY

In general, embodiments of the invention are directed to a method for scrolling through a graphical user interface (GUI) list control. The method involves obtaining a relative scrollbar position for a scrollbar thumb in a scrollbar. The scrollbar is associated with a scrollable window configured to display a subset of data items belonging to a list. Each data item in the list is defined with a height of the data item. A primary data item is determined from the list of data items. The primary data item has a relative list position in the list of data items. The relative list position in the list corresponds to a relative scrollbar position for the scrollbar thumb in the scrollbar. A relative scrollable window position in the scrollable window is determined. The relative scrollable window position in the scrollable window corresponds to the relative scrollbar position for the scrollbar thumb in the scrollbar. The primary data item is displayed at the relative scrollable window position in the scrollable window.

In general, embodiments of the invention are directed to a system for scrolling through a GUI list control. The system includes: (i) a processor; (ii) a persistent storage device configured to maintain data associated with a plurality of data items belonging to a list; (iii) a computer-readable memory device; (iv) an input device; (v) a display device; (vi) and a software application executing on the processor. The software application includes a GUI which is displayed to a user by the display device. The GUI includes a scrollable window, an upward scroll button, a downward scroll button, and a scrollbar. The scrollable window is configured to display a subset of the plurality of data items belonging to the list. The scrollbar includes a scrollbar thumb. The upward scroll button, the downward scroll button, and the scrollbar thumb are configured to receive input from the user using the input device. The software application is configured to obtain a user input from the user using the input device. The user input includes a relative scrollbar position for the scrollbar thumb in the scrollbar. The software is further configured to determine a primary data item from the plurality of data items. The primary data item has a relative list position in the list. The relative list position in the list corresponds to the relative scrollbar position for the scrollbar thumb in the scrollbar. The software application is further configured to determine a relative scrollable window position in the scrollable window. The relative scrollable window position in the scrollable window corresponds to the relative scrollbar position for the scrollbar thumb in the scrollbar. The software application is further configured to display the primary data item at the relative scrollable window position in the scrollable window.

In general, embodiments of the invention are directed to a computer readable medium including executable instructions for scrolling through a GUI list control. Executable instructions include instructions for obtaining a relative scrollbar position for a scrollbar thumb in a scrollbar. The scrollbar is associated with a scrollable window configured to display a subset of data items belonging to a list. Each data item in the list is defined with a height of the data item. Executable instructions further include instructions for determining a primary data item from the list of data items. The primary data item has a relative list position in the list of data items. The relative list position in the list corresponds to a relative scrollbar position for the scrollbar thumb in the scrollbar. Executable instructions further include instructions for determining a relative scrollable window position in the scrollable window. The relative scrollable window position in the scrollable window corresponds to the relative scrollbar position for the scrollbar thumb in the scrollbar. Executable instructions further include instructions for displaying the primary data item at the relative scrollable window position in the scrollable window.

Other aspects of the invention will be apparent from the following description and the appended claims.

### BRIEF DESCRIPTION OF DRAWINGS

FIGS. 1, 3, and 4 show flowcharts in accordance with one or more embodiments of the invention.

FIGS. 2a through 2j and 5 show examples in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying FIGs. Like elements in the various FIGs. are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for scrolling through a graphical user interface (GUI) list control. In one or more embodiments of the invention, a GUI list control includes, but is not limited to, a scrollbar and a scrollable window for displaying data items. In one or more embodiments of the invention, the data items may be maintained in a list data structure (e.g., linked list). In one or more other embodiments of the invention, the data items may be maintained using a tree data structure (e.g., binary tree).

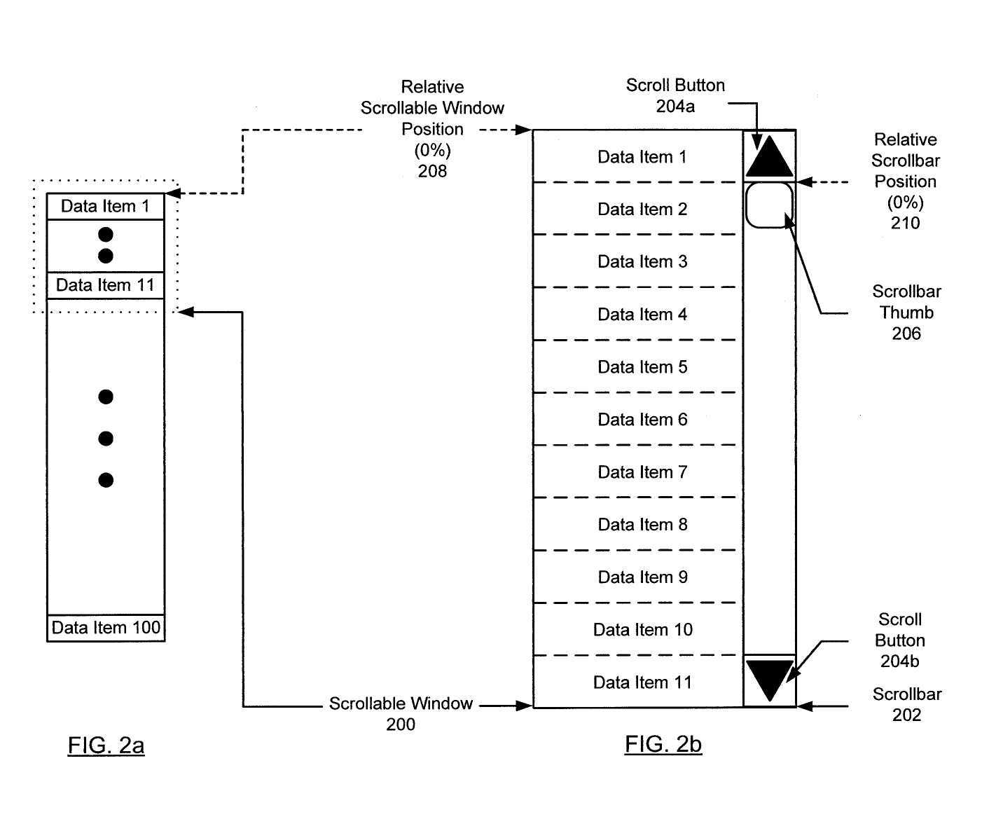

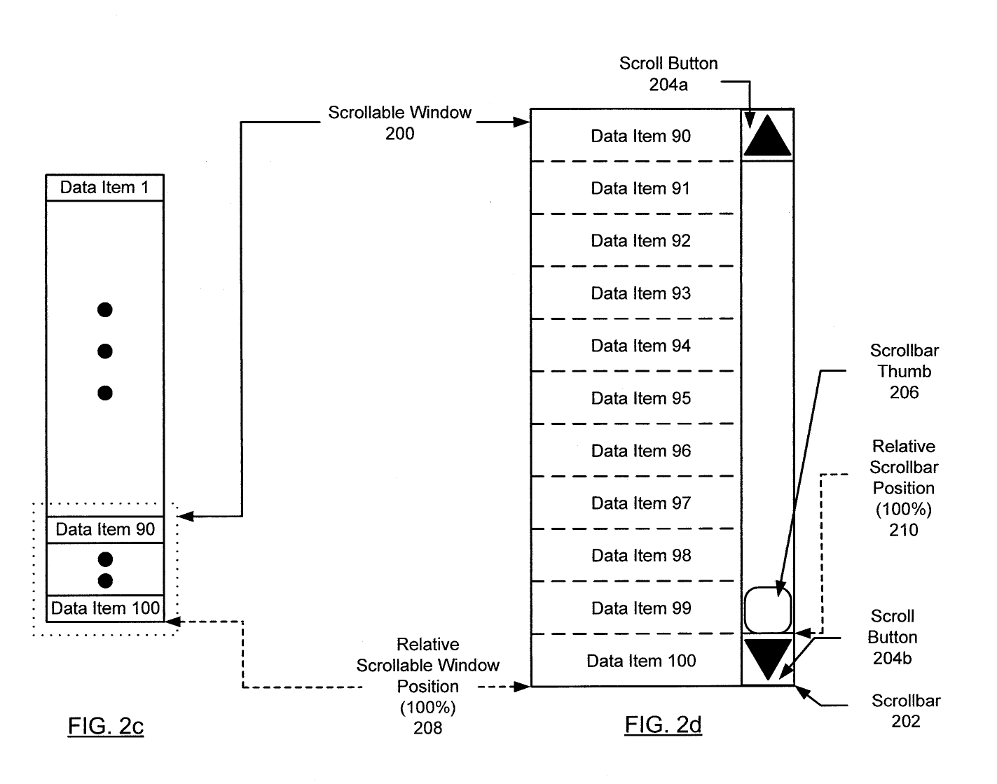

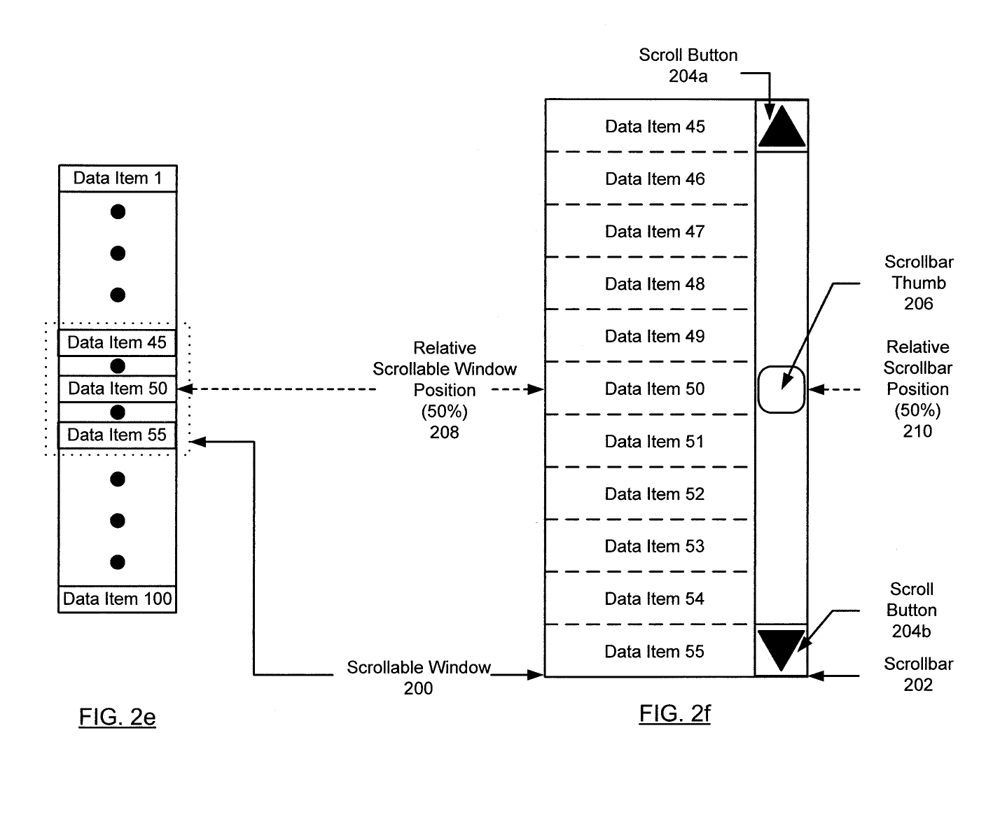

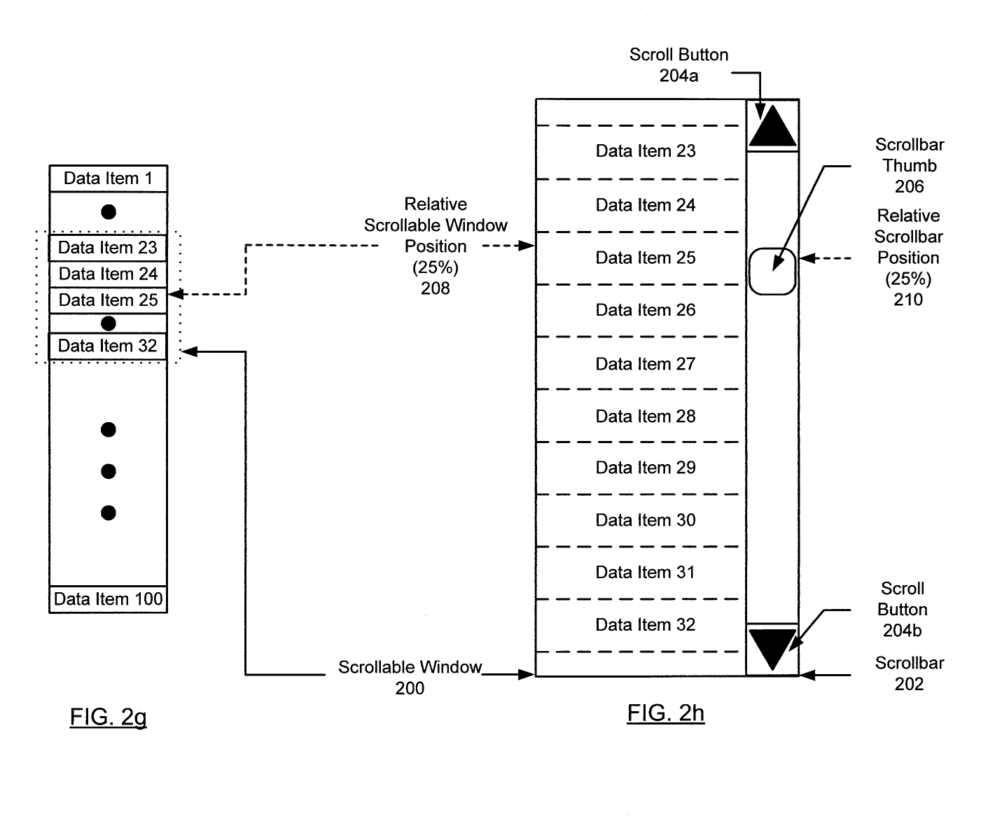

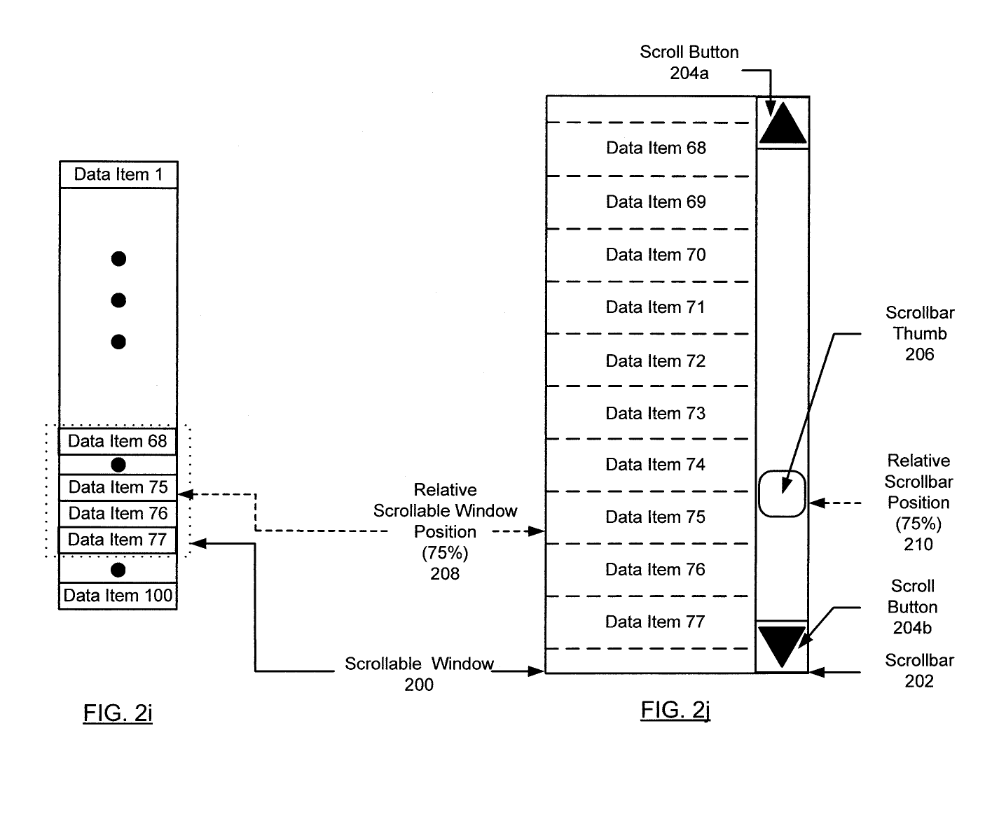

In one or more embodiments of the invention, a GUI list control may display data items to a user with a scrollable window (see, e.g., element 200 as shown in FIGS. 2b, 2d, 2f, 2h, and 2j). In one or more embodiments of the invention, the scrollable window may only display a subset of all the available data items at a given time. For example, a list data structure may store 100 data items. However, the scrollable window may only be large enough to show a few data items at a time. However, through scrolling functions made available by a scrollbar (see, e.g., element 202 as shown in FIGS. 2b, 2d, 2f, 2h, and 2j), the user may traverse the list to view any data item.

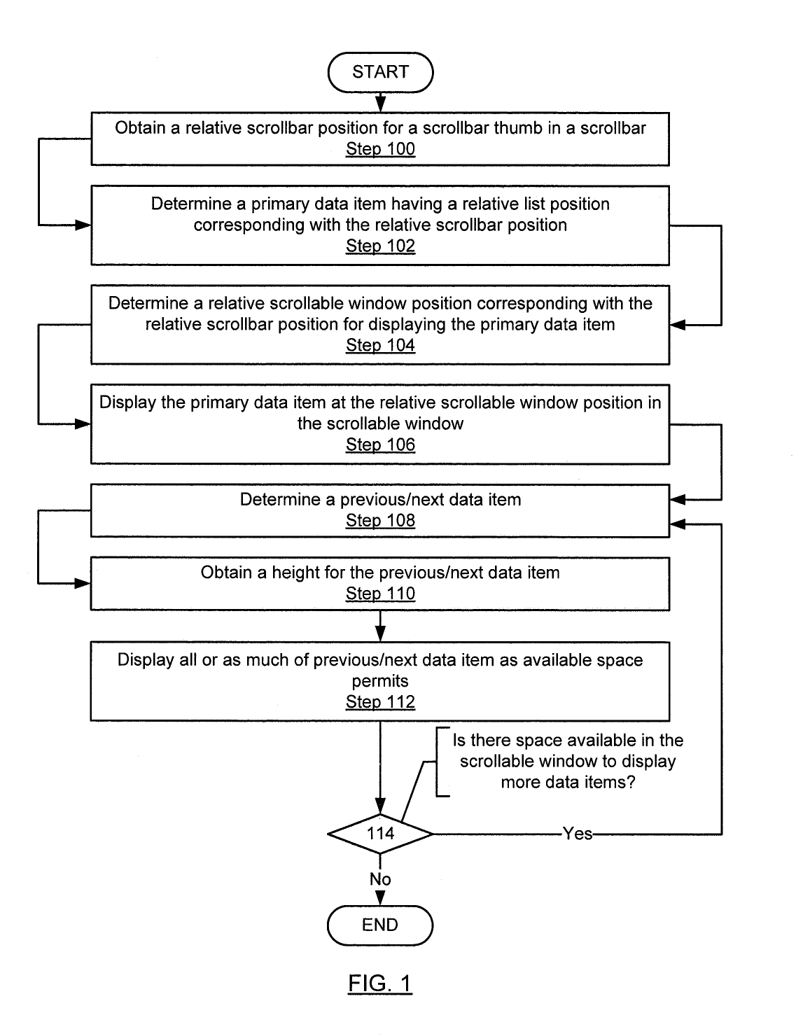

In one or more embodiments of the invention, a user may utilize position-based scrolling to logically traverse a list. Specifically, by using a scrollbar thumb (see, e.g., element 206 respectively as shown in FIGS. 2b, 2d, 2f, 2h, and 2j) in the scrollbar, the user may jump directly to any position in the list to view a data item (and adjacent data items) corresponding to the selected list position. Aside from using the scrollbar thumb, a user may also mouse-click (i.e., provide an input by clicking with a mouse device) a location in the scrollbar causing the scrollbar thumb to move to a new scrollbar position. Accordingly, the data items in the scrollable window are updated to display a subset of available data items corresponding to the selected list position. A more detailed discussion of position-based scrolling is provided in relation to FIG. 1 and FIGS. 2a-2j.

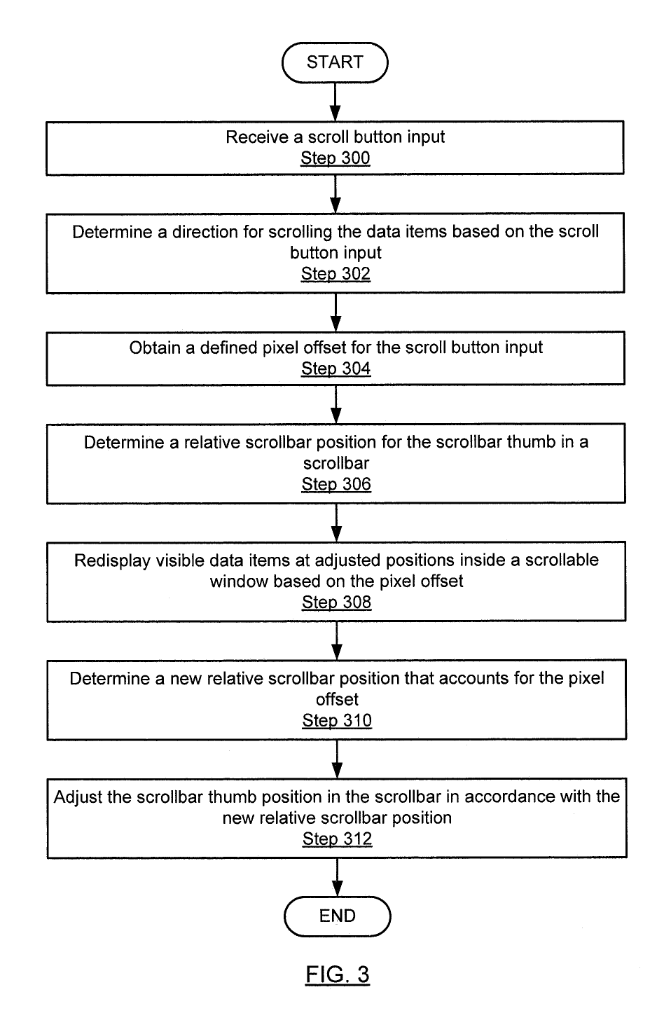

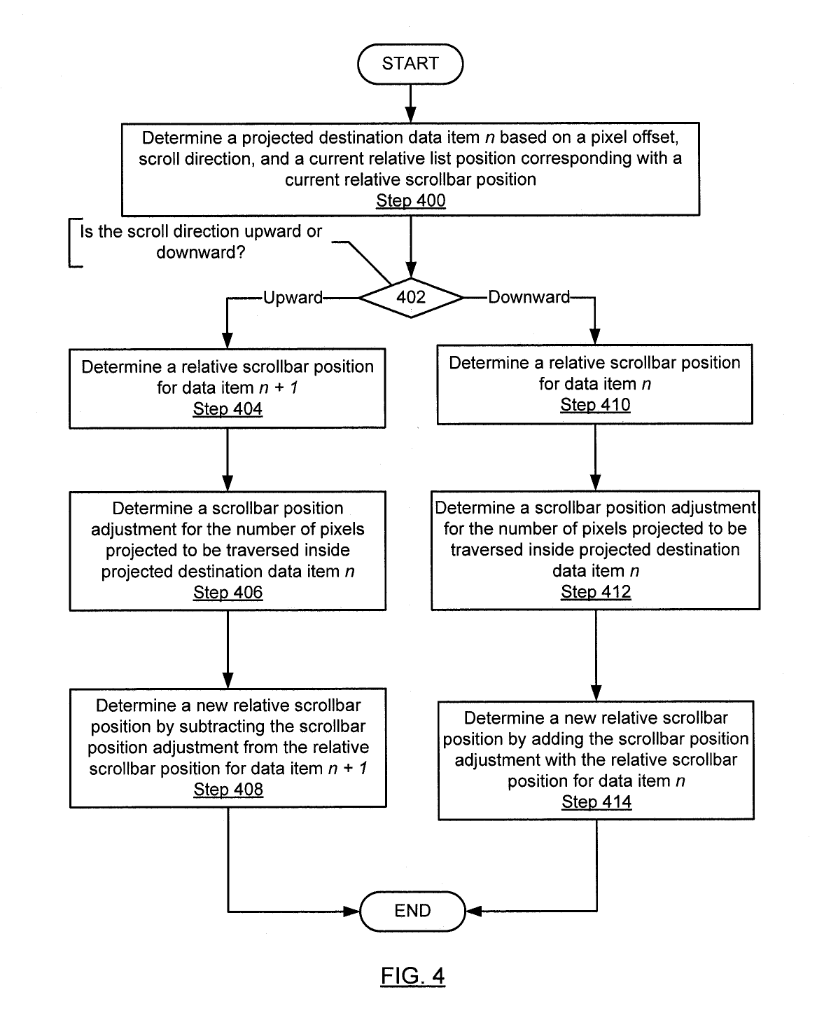

Alternatively, in one or more embodiments of the invention, a user may utilize pixel-based scrolling to physically traverse a list. Specifically, by using an upward or downward scroll button (see, e.g., elements 204a and 204b respectively as shown in FIGS. 2b, 2d, 2f, 2h, and 2j), the displayed data items in the scrollable window may be displaced upward or downward a pre-defined number of pixels at a time. A more detailed discussion of pixel-based scrolling will be provided in relation to FIG. 3.

In one or more embodiments of the invention, the scrollable window may be of a particular type depending on the format in which the data items are displayed. In one or more embodiments of the invention, the scrollable window may be a list view window configured to display data items in a list format. In such embodiments, data items are displayed in a sequential order allowing a user to navigate (i.e., traverse) up or down (i.e., toward a beginning or end) a list of data items. FIGS. 2b, 2d, 2f, 2h, and 2j provide an example of a list view window in accordance with one or more embodiments of the invention.

In one or more embodiments of the invention, the scrollable window may be a table view window configured to display data items in a table format. In such embodiments, a table with a number of rows and columns may be used to display one or more data items. For example, each row in the table may correspond to a particular data item. Further, in such embodiments, each column in a table may correspond to a type of information defined for the data item. For example, if each data item in the table represents a person, then table columns may correspond to types of information (e.g., height, weight, age, etc.) defined by the data item to describe people. In one or more embodiments of the invention, the table view window may allow a user to navigate up or down in a table to access different data items (i.e., table rows) as well as side to side in the table to access different information (i.e., table columns) for a data item.

In one or more embodiments of the invention, the scrollable window may be a tree view window configured to display data items in a tree format. In such embodiments, a hierarchical tree consisting of a number of nodes may be used to display one or more data items. In one or more embodiments of the invention, a binary tree may be used to display data items in a tree view window. For example, in one or more embodiments of the invention, each node in a tree may correspond to a data item. Alternatively, in one or more other embodiments of the invention, only leaf nodes in a tree may correspond to a data item. In one or more embodiments of the invention, the tree view window may allow a user to navigate up or down in a tree to access data items displayed at different node layers (i.e., root level, root level+1, etc.). In one or more embodiments of the invention, the tree view window may allow a user to navigate breadth-wise (i.e., right or left) in a tree to access all that data items displayed at a particular node layer.

FIG. 1 shows a flowchart in accordance with one or more embodiments of the invention. While the various steps in these flowcharts are presented and described sequentially, one should appreciate that some or all of the steps may be executed in different orders, may be combined or omitted, and some or all of the steps may be executed in parallel. In addition, steps have been omitted to simplify the presentation. The process shown in FIG. 1 may be used, for example, to provide position-based scrolling of data items in a list. In one or more embodiments of the invention, position-based scrolling may be performed when a user (i) utilizes the scrollbar thumb in the scrollbar or (ii) provides a mouse-click input at a location in the scrollbar causing the scrollbar thumb to move to a new relative scrollbar position

In Step 100, a relative scrollbar position is obtained for a scrollbar thumb in a scrollbar. In one or more embodiments of the invention, the relative scrollbar position may be provided as a decimal value. For example, if the relative scrollbar position is at a 25% mark between the beginning of the scrollbar and the end of the scrollbar, the relative scrollbar position may be provided as the decimal value 0.25 in Step 100.

In Step 102, a primary data item is determined using the relative scrollbar position. Specifically, the primary data item has a relative list position corresponding to the relative scrollbar position. For example, if the relative scrollbar position is 0.25, then the primary data item in a 100 item list would be the 25^{th} data item.

In some instances, a relative scrollbar position does not map directly to a whole number value. In such instances, embodiments of the invention would round up. For example, assume that a relative scrollbar position is 0.25 and a list associated with the GUI list control contains 99 items. Calculating 25% of 99 provides a value of 24.75. Said another way, the corresponding relative list position is three-quarters of the way through the 25^{th} data item. Accordingly, for purposes of determining a relative list position, rounding up from the true calculated value (i.e., 24.75) provides the 25^{th} data item as the primary data item.

In Step 104, a relative scrollable window position is determined using the relative scrollbar position. Specifically, the relative scrollable window position corresponds to the relative scrollbar position. For example, if the relative scrollbar position is 0.25, the relative scrollable window position would be located 25% of the way between the beginning of the scrollable window and the end of the scrollable window.

In Step 106, the primary data item is displayed at the relative scrollable window position in the scrollable window. For example, if the relative scrollbar position is 0.25, then the 25^{th} data item in a list of 100 data items would be displayed at a location 25% of the way between the beginning of the scrollable window and the end of the scrollable window.

In Step 108, a previous or a next data item is determined. In one or more embodiments of the invention, a previous data item is the data item that sequentially precedes the primary data item in the list. For example, if the primary data item is the 25^{th} data item in the list, then the previous data item is the 24^{th} data item in the list. In one or more embodiments of the invention, a next data item is the data item that sequentially follows the primary data item in the list. For example, if the primary data item is the 25^{th} data item in the list, then the next data item is the 26^{th} data item in the list.

In Step 110, a height value is determined for the previous/next data item. In one or more embodiments of the invention, each data item in a list has a defined height value. In one or more embodiments of the invention, data item heights are non-uniform. For example, the 25^{th} data item may have a height of 100 pixels while the 24^{th} and 26^{th} data items may have heights of 50 and 150 pixels respectively.

In Step 112, the previous/next data item is displayed in the scrollable window above/below the primary data item. In one or more embodiments of the invention, the entire previous/next data item is displayed if there is sufficient available space in the scrollable window above/below the primary data item. For example, if the previous data item has a height of 50 pixels and there are 100 pixels of available space between the beginning of the scrollable window and the beginning of the primary data item, then all of the previous data item is displayed in the scrollable window.

In one or more embodiments of the invention, as much of the previous/next data item is displayed above/below the primary data item as permitted by how much space is actually available. For example, if the previous data item has a height of 50 pixels and there are only 25 pixels of available space between the beginning of the scrollable window and the beginning of the primary data item, then only 25 pixels of the previous data item is displayed in the scrollable window. Specifically, only the bottom 25 pixels of the previous data item are displayed. In another example, if the next data item has a height of 50 pixels and there are only 25 pixels of available space between the end of the primary data item and the end of the scrollable window, then only 25 pixels of the next data item is displayed in the scrollable window. Specifically, only the top 25 pixels of the next data item is displayed.

In Step 114, a determination is made as to whether there is still available space (i.e., unpopulated by a displayed data item) in the scrollable window. If there is no available space in the scrollable window, the process shown in FIG. 1 finishes. If there is available space in the scrollable window, Step 108 is performed.

In one or more embodiments of the invention, Steps 108 through 114 function as an iterative loop for filling out the rest of the scrollable window once the primary data item has been determined and displayed. For example, if the primary data item is the 25^{th} data item, then the first pass through the Steps 108-114 loop may determine and display the 24^{th} data item. As such, if Step 114 indicates that there is still available space between the beginning of the scrollable window and the beginning of the 24^{th} data item, then a second pass through the Steps 108-114 loop may determine and display all or some of the 23^{rd} data item. The described process of filling out the rest of the scrollable window using Steps 108-114 works in a similar fashion with respect to available space that falls between the primary data item and the end of the scrollable window. For example, Step 114 may indicate that there is available space between the end of the 25^{th} data item and the end of the scrollable window. As such, a next pass through the Steps 108-114 loop may determine and display all or some of the 26^{th} data item.

FIGS. 2a through 2j show examples in accordance with one or more embodiments of the invention. The list used for purposes of example through these FIGs. is a 100-item list. The scrollable window is a list view window in accordance with one or more embodiments of the invention.

Specifically, FIG. 2b shows a list control GUI with a relative scrollbar position of 0%. FIG. 2a shows an accompanying logical view of the list. In this instance, because the relative scrollbar position is 0%, the primary data item is the data item corresponding to a relative list position of 0% through the list. Said another way, the primary data item is Data Item 1 (i.e., the absolute logical beginning of the list). Accordingly, because the relative scrollable window position corresponds to the relative scrollbar position, the relative scrollable window position is also 0%. Further, because the relative scrollable window position is 0%, Data Item 1 is displayed at the beginning of the scrollable window. In filling out the remainder of the scrollable window, there is no available space above Data Item 1 in the scrollable window. As such, there is no logical previous data item to display. However, because there is available space below Data Item 1, there are logical next data items to display. Accordingly, as FIG. 2b shows, Data Items 2-11 have been determined and displayed below primary Data Item 1 to fill out the remainder of the available space in the scrollable window. FIG. 2a depicts the list in entirety in accordance with the displayed data items (see, e.g., Data Items 1-11 falling within the scrollable window) and the relative scrollable window position.

FIG. 2d shows a list control GUI with a relative scrollbar position of 100%. FIG. 2c shows an accompanying logical view of the list. Because the relative scrollbar position is now 100%, the primary data item is the data item corresponding to a relative list position of 100% through the list. Said another way, the primary data item is Data Item 100 (i.e., the absolute logical end of the list). Accordingly, because the relative scrollable window position corresponds to the relative scrollbar position, the relative scrollable window position is also 100%. Further, because the relative scrollable window position is 100%, Data Item 100 is displayed at the end of the scrollable window. In filling out the remainder of the scrollable window, there is no available space below Data Item 100 in the scrollable window. As such, there is no logical next data item to display. However, because there is available space above Data Item 100, there are logical previous data items to display. Accordingly, as FIG. 2d shows, Data Items 90-99 have been determined and displayed above primary Data Item 100 to fill out the remainder of the available space in the scrollable window. FIG. 2b depicts the list in entirety in accordance with the displayed data items (see, e.g., Data Items 90-100 falling within the scrollable window) and the relative scrollable window position.

FIG. 2f shows a list control GUI with a relative scrollbar position of 50%. FIG. 2e shows an accompanying logical view of the list. Because the relative scrollbar position is 50%, the primary data item is the data item corresponding to a relative list position of 50% through the list. Said another way, the primary data item is Data Item 50 (i.e., the absolute logical middle of the list). Accordingly, because the relative scrollable window position corresponds to the relative scrollbar position, the relative scrollable window position is also 50%. Further, because the relative scrollable window position is 50%, Data Item 50 is displayed at the middle of the scrollable window. In filling out the remainder of the scrollable window, there is available space both above and below Data Item 50 in the scrollable window. As such, there is a need to fill in the available space to display both logical previous data items and logical next data items. Accordingly, as FIG. 2f shows, Data Items 45-49 and 51-55 have been determined and displayed above and below primary Data Item 1 to fill out the remainder of the available space in the scrollable window. FIG. 2e depicts the list in entirety in accordance with the displayed data items (see, e.g., Data Items 45-55 falling within the scrollable window) and the relative scrollable window position.

FIG. 2h shows a list control GUI with a relative scrollbar position of 25%.

FIG. 2g shows an accompanying logical view of the list. Because the relative scrollbar position is 25%, the primary data item is the data item corresponding to a relative list position of 25% through the list. Said another way, the primary data item is Data Item 25. Accordingly, because the relative scrollable window position corresponds to the relative scrollbar position, the relative scrollable window position is also 25%. Further, because the relative scrollable window position is 25%, Data Item 25 is displayed at the quarter-mark of the scrollable window. In filling out the remainder of the scrollable window, there is available space both above and below Data Item 25 in the scrollable window. As such, there is a need to fill in the available space to display both logical previous data items and logical next data items. Accordingly, as FIG. 2h shows, part of Data Item 22 and all of Data Items 23 and 24 have been determined and displayed above primary Data Item 25. Further, all of Data Items 26-32 and part of Data Item 33 have been determined and displayed below primary Data Item 25. FIG. 2g depicts the list in entirety in accordance with the displayed data items (see, e.g., all of Data Items 23-32 falling within the scrollable window) and the relative scrollable window position.

FIG. 2j shows a list control GUI with a relative scrollbar position of 75%. FIG. 2i shows an accompanying logical view of the list. Because the relative scrollbar position is 75%, the primary data item is the data item corresponding to a relative list position of 75% through the list. Said another way, the primary data item is Data Item 75. Accordingly, because the relative scrollable window position corresponds to the relative scrollbar position, the relative scrollable window position is also 75%. Further, because the relative scrollable window position is 75%, Data Item 75 is displayed at the three-quarters mark of the scrollable window. In filling out the remainder of the scrollable window, there is available space both above and below Data Item 75 in the scrollable window. As such, there is a need to fill in the available space to display both logical previous data items and logical next data items. Accordingly, as FIG. 2j shows, part of Data Item 67 and all of Data Items 68-74 have been determined and displayed above primary Data Item 75. Further, all of Data Items 76 and 77 and part of Data Item 78 have been determined and displayed below primary Data Item 75. FIG. 2i depicts the list in entirety in accordance with the displayed data items (see, e.g., all of Data Items 68-77 falling within the scrollable window) and the relative scrollable window position.

FIG. 3 shows a flowchart in accordance with one or more embodiments of the invention. While the various steps in these flowcharts are presented and described sequentially, one should appreciate that some or all of the steps may be executed in different orders, may be combined or omitted, and some or all of the steps may be executed in parallel. In addition, steps have been omitted to simplify the presentation. The process shown in FIG. 3 may be used, for example, to provide pixel-based scrolling of data items in a list. In one or more embodiments of the invention, pixel-based scrolling is performed when (i) a user utilizes the directional (i.e., upward, downward) scroll buttons associated with the scrollbar or (ii) a user uses the mouse or a finger touch gesture to drag the scrollable window (i.e., panning).

In Step 300, a scroll button input is received. In one or more embodiments of the invention, a scroll button input may be received when a user pushes one of the two directional scrollbar buttons (see, e.g., upward or downward) associated with the scrollbar.

In Step 302, a direction for scrolling the displayed data items in the scrollable window is determined using the scroll button input. In one or more embodiments of the invention, the scrollbar provides a first button for scrolling upward and a second button for scrolling downward.

In Step 304, a pre-defined pixel offset for the scroll button input is obtained. In one or more embodiments of the invention, a pixel offset is defined by a software application for moving the displayed data items a constant number of pixels upward or downward in the scrollable window. For example, if the pixel offset constant is defined as 50, then the pushing of a scroll button will either move all the displayed data items 50 pixels in either the upward or downward direction.

In Step 306, a relative scrollbar position is determined for the scrollbar thumb in the scrollbar before any changes have been made to the scrollable window or the scrollbar. In one or more embodiments of the invention, the relative scrollbar position may be provided as a decimal value. For example, if the relative scrollbar position is at a 25% mark between the beginning of the scrollbar and the end of the scrollbar, the relative scrollbar position may be provided as the decimal value 0.25.

In Step 308, the data items displayed in the scrollable window are redisplayed at new adjusted positions based on the pixel offset. For example, assume that a displayed data item begins at 200 pixels from the top of the scrollable window and ends at 300 pixels from the top of the scrollable window. If the pixel offset is 50 pixels and the scrolling direction is downward, then the new adjusted position for the displayed data item is one where the data item begins 250 pixels from the top of the scrollable window and ends at 350 pixels from the top of the scrollable window. Alternatively, if the pixel offset remains 50 pixels but the scrolling direction is upward, then the new adjusted position for the displayed data item is one where the data item begins 150 pixels from the top of the scrollable window and ends at 250 pixels from the top of the scrollable window. Accordingly, the effect of executing Step 308 is that the pixel offset would be uniformly applied to each of the displayed data items.

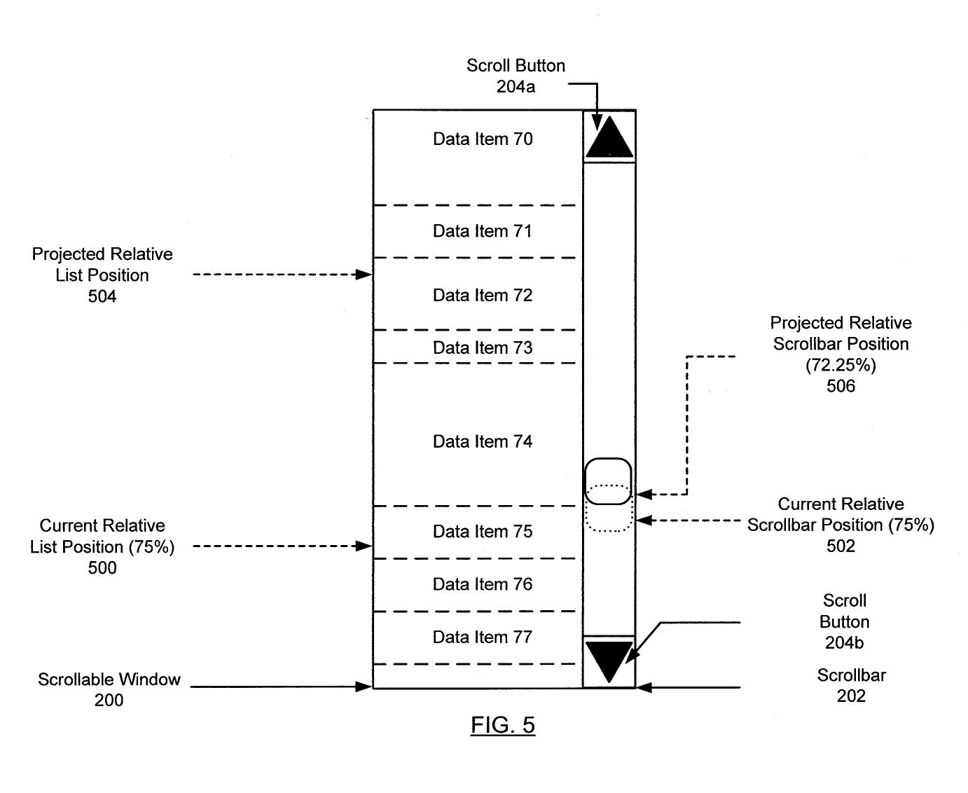

In Step 310, a new relative scrollbar position is determined to account for the application of the pixel offset to each of the data items displayed in the scrollable window. Further detail with regards to Step 310 is provided in relation to FIGS. 4 and 5 in accordance with one or more embodiments of the invention. In Step 312, the scrollbar thumb is adjusted to the newly-determined relative scrollbar position.

FIG. 4 shows a flowchart in accordance with one or more embodiments of the invention. While the various steps in these flowcharts are presented and described sequentially, one should appreciate that some or all of the steps may be executed in different orders, may be combined or omitted, and some or all of the steps may be executed in parallel. In addition, steps have been omitted to simplify the presentation. In one or more embodiments of the invention, the process shown in FIG. 4 may be used, for example, to determine a new relative scrollbar position to account for a scroll button event. For example, in such embodiments of the invention, the process shown in FIG. 4 may be used to perform Step 310 as discussed in relation to FIG. 3.

In Step 400, a projected destination data item is determined based on a pixel offset, scroll direction, and a current relative list position corresponding to a current relative scrollbar position. In one or more embodiments of the invention, the pixel offset is determined in response to a scroll button event as discussed in relation to Step 304 of FIG. 3. In one or more embodiments of the invention, the scroll direction is determined in response to a scroll button event as discussed in relation to Step 302 of FIG. 3. In one or more embodiments of the invention, the current relative list position is determined as discussed in relation to Step 102 of FIG. 1.

In determining a projected destination data item, a movement is projected beginning at the current relative list position and ending a specified number of pixels (i.e., the pixel offset) further up or down (depending on scroll direction) the list. The location at which the projected movement ends determines the projected destination data item.

In Step 402, a determination is made as to whether the scroll direction is upward or downward. If the scroll direction is upward, Steps 404-408 are performed. Alternatively, if the scroll direction is downward, Steps 410-414 are performed.

In Step 404, a relative scrollbar position is determined for the data item that logically follows the projected destination data item. In one or more embodiments of the invention, the relative scrollbar position for data item n in a list of t data items may be found as shown below:

relative scrollbar position(n)=(1/t)×n

In Step 406, a scrollbar position adjustment is determined for the number of pixels projected to be traversed inside the projected destination data item. In one or more embodiments of the invention, the scrollbar position adjustment may be determined as shown below, where t is the total number of data items, h is the height in pixels of the projected destination data item, and z is the number of pixels travelled inside the projected destination data item:

scrollbar position adjustment=((1/t)/h)×z

In Step 408, a new relative scrollbar position is determined by subtracting the scrollbar position adjustment from the relative scrollbar position of the data item that logically follows the projected destination data item.

In Step 410, a relative scrollbar position is determined for the data item that logically precedes the projected destination data item. In one or more embodiments of the invention, a relative scrollbar position may be determined as shown in relation to Step 404.

In Step 412, a scrollbar position adjustment is determined for the number of pixels projected to be traversed inside the projected destination data item. In one or more embodiments of the invention, a scrollbar position adjustment may be determined as shown in relation to Step 406.

In Step 414, a new relative scrollbar position is determined by adding the scrollbar position adjustment with the relative scrollbar position of the data item that logically precedes the projected destination data item.

FIG. 5 shows an example in accordance with one or more embodiments of the invention. Specifically, FIG. 5 will be used to demonstrate how the process of FIG. 4 may be used to determine a new relative scrollbar position to account for a scroll button event. In particular, FIG. 5 shows a list control GUI with a 100-data item list and an original relative scrollbar position (502) of 75%. For purposes of example, assume the pixel offset is 216 pixels in an upward scroll direction. Further, assume that Data Item 75 has a pixel height of 32 pixels, Data Item 74 has a pixel height of 128 pixels, Data Item 73 has a pixel height of 16 pixels, and Data Item 72 has a pixel height of 64 pixels.

At the outset, the current relative scrollbar position (502) is mapped to a corresponding current relative list position (500). Accordingly, for this example, the current relative scrollbar position (502) of 75% maps to a position that is 75% through Data Item 75 (500). As such, the current relative list position is 24 pixels through Data Item 75.

A projected movement of 216 pixels in an upward direction with respect to the list traverses: (i) the top three-quarters of Data Item 75 (i.e., 24 pixels); (ii) all of Data Item 74 (i.e., 128 pixels); (iii) all of Data Item 73 (i.e., 16 pixels); and (iv) the bottom 48 pixels of Data Item 72. Accordingly, the projected movement determines a new relative list position (504) 25% of the way through Data Item 72. Because the scroll direction is upward, a relative scrollbar position for Data Item 73 (i.e., the data item that logically follows the projected destination data item) is used as a pre-adjustment baseline pursuant to Step 404 of FIG. 4. Accordingly, the relative scrollbar position for Data Item 73 is evaluated as (1/100)×73=0.73. Pursuant to Step 406, the relative scrollbar position for Data Item 73 must be adjusted in view of the number of pixels projected to be traversed in Data Item 72 (i.e., the projected destination data item). This adjustment is evaluated as ((1/100)/64)×48=0.0075. To determine the new relative scrollbar position, the adjustment for the pixels traversed in Data Item 72 must be subtracted from the relative scrollbar position of Data Item 73. As such, 0.73−0.0075=0.7225 as the new relative scrollbar position.

As discussed in relation to the FIGs., embodiments of the invention account for a data item height when displaying a data item. Further, each data item may have a unique data item height. In one or more embodiments, a unique height (in addition to any other custom property for a data item) may be maintained for each data item. Per-data item definitional data may be maintained in a number of ways. For example, each data item may have an entry in a database for purposes of defining the unique properties of the data item. Each data item may be associated with its own particular file stored using a persistent storage device.

In one or more embodiments of the invention, the number of total data items in a list may be large. For example, maintaining a list with over one million data items where each one of the data items is instantiated in memory taxes the resources of a computer system. As such, data items and their accompanying definitional information may be timely retrieved when needed. For example, a GUI list control may be initialized to display Data Items 1-11 as shown in FIG. 2b. However, if a user utilizes the scroll thumb function to logically-scroll to the end of the list as shown in FIG. 2d, then the GUI list control may need to be updated to display a different set of data items (see, e.g., Data Items 90-100). As such, the need to retrieve data pertinent to the latter set of data items only arises when the user has performed the scrolling function that requires display of those aforementioned data items.

Memory resources for a computer system may similarly be conserved through the reuse of GUI objects when possible. For example, displaying each of the Data Items 1-11 as shown in FIG. 2b requires the use of a GUI object (e.g., as defined by a ListCell class). As such, 11 GUI objects are required to display Data Items 1-11. Assume, as before, that a user transitions from the state shown in FIG. 2b (i.e., displaying Data Items 1-11) directly to the state shown in FIG. 2d (i.e., displaying Data Items 90-100) using position-based scrolling. While 11 GUI objects are still required in the second state, the data items represented by those GUI objects in the second state are appreciably different from the data items required in the first state. In such instances, embodiments of the invention allow for object reusability. Specifically, rather than releasing the GUI objects used to display Data Items 1-11 for garbage collection, embodiments of the invention may be reinitialized the aforementioned GUI objects with the unique properties pertinent in the display of Data Items 90-100. As such, the task of instantiating new GUI objects is minimized when previously-instantiated GUI objects are available for reinitialization and reuse. This is of particular benefit in use cases where the number of data items in a list is large. For example, maintaining a list of one million GUI objects in memory is not an efficient use of system resources. Rather, by instantiating a much smaller pool of GUI objects which can be utilized pursuant to a reuse scheme as described above, embodiments of the invention enable the management of a large list of data items that can be traversed and viewed by a user of a GUI list control.

Pursuant to the ability to maintain and manage a list with a high volume of entries, embodiments of the invention may be utilized in conjunction with, for example, a scene graph as implemented using Java3D™. (Java3D is a trademark of Sun Microsystems, Inc. of Santa Clara, Calif.). A scene graph is a hierarchical tree representing object information necessary to display one or more graphical elements as necessary. Specifically, a scene graph may consist of various group nodes arranged in a tree structure, where each group node may have one or more leaf node objects. In accordance with one or more embodiments of the invention, a set of leaf node objects collected together under a single group node in a scene graph may be displayed by a GUI list control such that each leaf node object is represented by a data item.

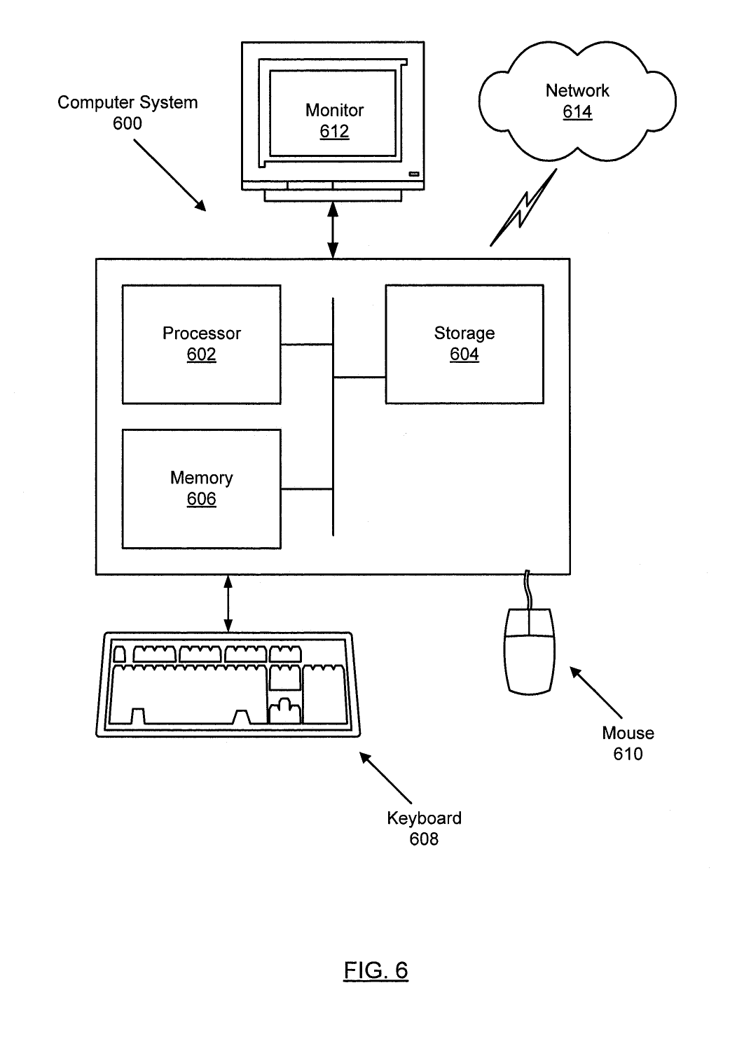

Embodiments of the invention may be implemented on virtually any type of computer regardless of the platform being used. For example, as shown in FIG. 6, a computer system (600) includes one or more processors (602), associated memory (606) (e.g., random access memory (RAM), cache memory, flash memory, etc.), a storage device (604) (see, e.g., a hard disk, an optical drive such as a compact disk drive or digital video disk (DVD) drive, a flash memory stick, etc.), and numerous other elements and functionalities typical of today's computers (not shown). The computer (600) may also include input means, such as a keyboard (608), a mouse (610), or a microphone (not shown). Further, the computer (600) may include output means, such as a monitor (612) (see, e.g., a liquid crystal display (LCD), a plasma display, or cathode ray tube (CRT) monitor). The computer system (600) may be connected to a network (614) (see, e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system (600) includes at least the minimal processing, input, and/or output means necessary to practice embodiments of the invention.

Further, those skilled in the art will appreciate that one or more elements of the aforementioned computer system (600) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for scrolling through a graphical user interface (GUI) list control, comprising:
obtaining a first relative scrollbar position for a scrollbar thumb in a scrollbar, wherein the scrollbar is associated with a scrollable window configured to display a subset of a first plurality of data items belonging to a list, and wherein each one of the data items in the first plurality of data items is defined with a height of the data item;
determining a primary data item from the first plurality of data items, wherein the primary data item has a relative list position in the list, and wherein the relative list position in the list corresponds to the first relative scrollbar position for the scrollbar thumb in the scrollbar;
determining a relative scrollable window position in a scrollable window, wherein the relative scrollable window position in the scrollable window corresponds to the first relative scrollbar position for the scrollbar thumb in the scrollbar; and
displaying the primary data item at the relative scrollable window position in the scrollable window.

2. The method of claim 1, further comprising:
determining a first previous data item, wherein the first previous data item precedes the primary data item in the list;
determining a first height of the first previous data item;
determining a first available space measurement, wherein the first available space measurement is the amount of available space between the beginning of the scrollable window and the beginning of the primary data item;
when the first height is not less than the first available space measurement:
displaying all of the first previous data item at a position above the primary data item in the scrollable window;
when the first height is less than the first available space measurement:
displaying a bottom portion of the first previous data item at a position above the primary data item in the scrollable window, wherein the size of the bottom portion equals the first available space measurement;
determining a first next data item, wherein the first next data item follows the primary data item in the list;
determining a second height of the first next data item;
determining a second available space measurement, wherein the second available space measurement is the amount of available space between the end of the primary data item and the end of the scrollable window;
when the second height is not less than the second available space measurement:
displaying all of the first next data item at a position below the primary data item in the scrollable window; and
when the second height is less than the second available space measurement:
displaying a top portion of the first next data item at a position below the primary data item in the scrollable window, wherein the size of the top portion equals the second available space measurement.

3. The method of claim 1, further comprising:
receiving a scroll button input, wherein the scroll button is associated with the scrollable window;
determining a direction for scrolling the displayed data items in the scrollable window based on the scroll button input;
determining a defined pixel offset for the scroll button input;
redisplaying the subset of the first plurality of data items at adjusted positions inside the scrollable window using the pixel offset;
determining a second relative scrollbar position when the subset of the first plurality of data items has been redisplayed inside the scrollable window using the pixel offset; and
adjusting the scrollbar thumb in the scrollbar to the second relative scrollbar position.

4. The method of claim 2, wherein the first height of the first previous data item, the second height of the first next data item, and a height of the primary data item are non-uniform.

5. The method of claim 2,
wherein displaying the primary data item comprises:
obtaining a first data item graphical user interface (GUI) object; and
configuring the first data item GUI object with the height of the primary data item;
wherein displaying the first previous data item comprises:
obtaining a second data item GUI object; and
configuring the second data item GUI object with the first height;
wherein displaying the first next data item comprises:
obtaining a third data item GUI object; and
configuring the third data item GUI object with the second height,
wherein the first data item GUI object, the second data item GUI object, and the third data item GUI object are previously-instantiated in memory.

6. The method of claim 1, wherein each one of the data items in the first plurality of data items is a node in a scene graph.

7. The method of claim 1, wherein the scrollable window is one selected from a group consisting of a list view window, a table view window, and a tree view window.

8. A system for scrolling through a graphical user interface (GUI) list control, comprising:
a processor;
a persistent storage device configured to maintain data associated with a first plurality of data items belonging to a list;
an input device;
a display device; and
a software application executing on the processor, wherein the software application comprises a GUI which is displayed to a user by the display device, wherein the GUI comprises:
a scrollable window configured to display a subset of a first plurality of data items belonging to a list;
an upward scroll button;
a downward scroll button; and
a scrollbar comprising a scrollbar thumb,
wherein the upward scroll button, the downward scroll button, and the scrollbar are configured to receive input from a user using the input device,
wherein the software application is configured to:
obtain a first user input from a user using the input device, wherein the first user input comprises a first relative scrollbar position for the scrollbar thumb in the scrollbar;
determine a primary data item from the first plurality of data items, wherein the primary data item has a relative list position in the list, and wherein the relative list position in the list corresponds to the first relative scrollbar position for the scrollbar thumb in the scrollbar;
determine a relative scrollable window position in the scrollable window, wherein the relative scrollable window position in the scrollable window corresponds to the first relative scrollbar position for the scrollbar thumb in the scrollbar; and
display the primary data item at the relative scrollable window position in the scrollable window.

9. The system of claim 8, wherein each one of the data items in the first plurality of data items is defined with a height of the data item, and wherein the software application, when executed by the processor, is further configured to:
determine a first previous data item, wherein the first previous data item precedes the primary data item in the list;
determine a first height of the first previous data item;
determine a first available space measurement, wherein the first available space measurement is the amount of available space between the beginning of the scrollable window and the beginning of the primary data item;
when the first height is not less than the first available space measurement:
display all of the first previous data item at a position above the primary data item in the scrollable window;
when the first height is less than the first available space measurement:
display a bottom portion of the first previous data item at a position above the primary data item in the scrollable window, wherein the size of the bottom portion equals the first available space measurement;
determine a first next data item, wherein the first next data item follows the primary data item in the list;
determine a second height of the first next data item;
determine a second available space measurement, wherein the second available space measurement is the amount of available space between the end of the primary data item and the end of the scrollable window;
when the second height is not less than the second available space measurement:
display all of the first next data item at a position below the primary data item in the scrollable window; and
when the second height is less than the second available space measurement:
display a top portion of the first next data item at a position below the primary data item in the scrollable window, wherein the size of the top portion equals the second available space measurement.

10. The system of claim 8, wherein the software application, when executed by the processor, is further configured to:
receive a scroll button input from a user;
determine a direction for scrolling the displayed data items in the scrollable window based on the scroll button input;
obtain a defined pixel offset for the scroll button input;
redisplay the subset of the first plurality of data items at adjusted positions inside the scrollable window using the pixel offset;
determine a second relative scrollbar position when the subset of the first plurality of data items has been redisplayed inside the scrollable window using the pixel offset; and
adjust the scrollbar thumb in the scrollbar to the second relative scrollbar position.

11. The system of claim 9, wherein the first height of the first previous data item, the second height of the first next data item, and a height of the primary data item are non-uniform.

12. The system of claim 9,
wherein displaying the primary data item comprises:
obtaining a first data item graphical user interface (GUI) object; and
configuring the first data item GUI object with the height of the primary data item;
wherein displaying the first previous data item comprises:
obtaining a second data item GUI object; and
configuring the second data item GUI object with the first height;
wherein displaying the first next data item comprises:
obtaining a third data item GUI object; and
configuring the third data item GUI object with the second height,
wherein the first data item GUI object, the second data item GUI object, and the third data item GUI object are previously-instantiated in memory.

13. The system of claim 9, wherein each one of the data items in the first plurality of data items is a node in a scene graph.

14. The system of claim 8, wherein the scrollable window is one selected from a group consisting of a list view window, a table view window, and a tree view window.

15. A computer readable medium comprising executable instructions for scrolling through a graphical user interface list control, wherein executable instructions comprise instructions to:
obtain a first relative scrollbar position for a scrollbar thumb in a scrollbar, wherein the scrollbar is associated with a scrollable window configured to display a subset of a first plurality of data items belonging to a list;
determine a primary data item from the first plurality of data items, wherein the primary data item has a relative list position in the list, and wherein the relative list position in the list corresponds to the first relative scrollbar position for the scrollbar thumb in the scrollbar;
determine a relative scrollable window position in a scrollable window, wherein the relative scrollable window position in the scrollable window corresponds to the first relative scrollbar position for the scrollbar thumb in the scrollbar; and
display the primary data item at the relative scrollable window position in the scrollable window.

16. The computer readable medium of claim 15, wherein each one of the data items in the first plurality of data items is defined with a height of the data item, and wherein the computer readable medium comprises further executable instructions to:
determine a first previous data item, wherein the first previous data item precedes the primary data item in the list;
determine a first height of the first previous data item;
determine a first available space measurement, wherein the first available space measurement is the amount of available space between the beginning of the scrollable window and the beginning of the primary data item;
when the first height is not less than the first available space measurement:
display all of the first previous data item at a position above the primary data item in the scrollable window;
when the first height is less than the first available space measurement:
display a bottom portion of the first previous data item at a position above the primary data item in the scrollable window, wherein the size of the bottom portion equals the first available space measurement;
determine a first next data item, wherein the first next data item follows the primary data item in the list;
determine a second height of the first next data item;
determine a second available space measurement, wherein the second available space measurement is the amount of available space between the end of the primary data item and the end of the scrollable window;
when the second height is not less than the second available space measurement:
display all of the first next data item at a position below the primary data item in the scrollable window; and
when the second height is less than the second available space measurement:
display a top portion of the first next data item at a position below the primary data item in the scrollable window, wherein the size of the top portion equals the second available space measurement.

17. The computer readable medium of claim 15, comprising further executable instructions to:
receive a scroll button input, wherein the scroll button is associated with the scrollable window;
determine a direction for scrolling the displayed data items in the scrollable window based on the scroll button input;
obtain a defined pixel offset for the scroll button input;
redisplay the subset of the first plurality of data items at adjusted positions inside the scrollable window using the pixel offset;
determine a second relative scrollbar position when the subset of the first plurality of data items has been redisplayed inside the scrollable window using the pixel offset; and
adjust the scrollbar thumb in the scrollbar to the second relative scrollbar position.

18. The computer readable medium of claim 16, wherein the first height of the first previous data item, the second height of the first next data item, and a height of the primary data item are non-uniform.

19. The computer readable medium of claim 16,
wherein executable instructions for displaying the primary data item further comprise executable instructions to:
obtain a first data item graphical user interface (GUI) object; and
configure the first data item GUI object with the height of the primary data item;
wherein executable instructions for displaying the first previous data item further comprise executable instructions to:
obtaining a second data item GUI object; and
configuring the second data item GUI object with the first height;
wherein executable instructions for displaying the first next data item further comprise executable instructions to:
obtaining a third data item GUI object; and
configuring the third data item GUI object with the second height,
wherein the first data item GUI object, the second data item GUI object, and the third data item GUI object are previously-instantiated in memory.

20. The computer readable medium of claim 17, wherein each one of the data items in the first plurality of data items is a leaf node in a scene graph.
